(19) United States
(12) Patent Application Publication
(10) Pub. No.: US 2023/0343125 A1
(43) Pub. Date: Oct. 26, 2023

(54) Handwriting Recognition Method and Apparatus, Handwriting Recognition System and Interactive Display

(71) Applicant: BOE TECHNOLOGY GROUP CO., LTD., Chaoyang District, Beijing (CN)

(72) Inventor: Jiahui Bian, Beijing (CN)

(21) Appl. No.: 17/789,592

(22) PCT Filed: Jul. 20, 2021
(86) PCT No.: PCT/CN2021/107460

§ 371 Date: Jun. 28, 2022

(30) Foreign Application Priority Data
Feb. 1, 2021 (WO) PCT/CN2021/074622
May 31, 2021 (WO) PCT/CN2021/097349

(51) Int. Cl. G06V 30/32

(52) U.S. Cl. CPC G06V 30/32

(57) ABSTRACT

In this disclosure, there are provided a handwriting recognition method and apparatus, the handwriting recognition method including: detecting information of a plurality of trajectory points corresponding to a handwritten trajectory of a user on a handwriting screen, the information including a coordinate, the trajectory points including a starting trajectory point and a current trajectory point; determining whether the trajectory point is an ending trajectory point according to a determining condition, if the current trajectory point meets the determining condition, taking the current trajectory point as the ending trajectory point, and taking trajectory point between the starting trajectory point and the ending trajectory point as first to-be-recognized trajectory points; recognizing the first to-be-recognized trajectory points by using a text recognition model to obtain a first text recognition result; and displaying the first text recognition result in a form of print in a first display area of the handwriting screen.

### CROSS-REFERENCE TO RELATED APPLICATIONS

This application is the United States national phase of International Application No. PCT/CN2021/107460 filed Jul. 20, 2021, and claims priority to the applications PCT/CN2021/074622 filed on Feb. 1, 2021 and PCT/CN2021/097349 filed on May 31, 2021, the disclosures of which are hereby incorporated by reference in their entirety.

### TECHNICAL FIELD

Embodiments of this disclosure relate to the field of computer technologies, and particularly, to a handwriting recognition method and apparatus, a handwriting recognition system and an interactive display.

### BACKGROUND

In a related handwriting recognition method, generally, after a user has written on an electronic whiteboard, a handwritten trajectory is recognized, and text of a recognition result is stored in the form of a document. If the user wants to view the recognition result, he/she must open the document in the background for browsing; if the user wants to confirm whether there is an error in the recognition result, word-by-word comparison with the original handwritten trajectory is needed, and if there is an error in the recognition result, second editing in the document is needed. This interactive mode is very inconvenient for the user to use and has low recognition efficiency.

### SUMMARY

In the embodiments of the present disclosure, there are provided a handwriting recognition method and apparatus, for solving the problem in the related handwriting recognition method that the handwriting recognition result cannot be viewed in real time by the user.

In order to solve the above technical problem, the present disclosure is implemented as follows.

In a first aspect of the embodiments of the present disclosure, there is provided a handwriting recognition method, comprising:
detecting information of a plurality of trajectory points corresponding to a handwritten trajectory of a user on a handwriting screen, the information comprising a coordinate, the plurality of trajectory points comprising a starting trajectory point and a current trajectory point;
determining whether the current trajectory point is an ending trajectory point according to a determining condition, if the current trajectory point meets the determining condition, taking the current trajectory point as the ending trajectory point, and taking trajectory points between the starting trajectory point and the ending trajectory point as first to-be-recognized trajectory points;
recognizing the first to-be-recognized trajectory points by using a text recognition model to obtain a first text recognition result; and
displaying the first text recognition result in a form of print in a first display area of the handwriting screen.

In some embodiments, the information further comprises a user writing state, which comprises pen-starting, pen-moving or pen-lifting, the determining condition is that no new trajectory point is detected within a preset duration after a pen-lifting moment of the current trajectory point, and the starting trajectory point is a next trajectory point of a last trajectory point inputted to the text recognition model last time, or a first trajectory point of the handwriting screen.

In some embodiments, the displaying the first text recognition result in a form of print in a first display area of the handwriting screen comprises:
storing a plurality of words comprised in the first text recognition result as word trajectories, wherein each word is respectively stored as one word trajectory.

In some embodiments, the displaying the first text recognition result in a form of print in a first display area of the handwriting screen comprises:
respectively drawing each word comprised in the first text recognition result.

In some embodiments, after displaying the first text recognition result in the form of print, the method comprises:
receiving an erasure operation of the user on a target text in the first text recognition result, and erasing the target text.

In some embodiments, the erasure operation comprises selecting the target text.

In some embodiments, the erasure operation comprises a first erasure gesture, and the erasing the target text comprises:
erasing a word trajectory intersected with a trajectory of the first erasure gesture.

In some embodiments, the erasure operation comprises a second erasure gesture, and the erasing the target text comprises:
erasing a word trajectory intersected with a trajectory of the second erasure gesture, and erasing a word trajectory having a same label as the word trajectory.

In some embodiments, the label comprises a first label or a second label, wherein the first label comprises row information of the word trajectory and the second label comprises time information, paragraph information, or batch information of the word trajectory.

In some embodiments, the displaying the first text recognition result in a form of print in a first display area of the handwriting screen comprises:
performing row division on the first to-be-recognized trajectory points; and
respectively drawing the plurality of words comprised in the first text recognition result row by row according to a result of the row division.

In some embodiments, the performing row division on the first to-be-recognized trajectory points comprises:
dividing the first to-be-recognized trajectory points into the plurality of words according to the information of the trajectory points in the first to-be-recognized trajectory points; and
determining whether two adjacent words are in a same row, wherein the two adjacent words comprise a first word written earlier and a second word written later.

In some embodiments, the determining whether two adjacent words are in a same row comprises:
determining whether the two adjacent words are in the same row according to a height and a position coordinate of the second word, and a height and a position coordinate of the first word.

In some embodiments, the handwriting recognition method further comprises:
erasing the target text according to the erasure operation of the user on the target text in the first text recognition result, and erasing a word trajectory belonging to the same row as the target text.

In some embodiments, the handwriting recognition method further comprises:
detecting information of second to-be-recognized trajectory points corresponding to the handwritten trajectory of the user on the handwriting screen, the information comprising a coordinate, time and a user writing state, the user writing state comprising: pen-starting, pen-moving, and pen-lifting; the second to-be-recognized trajectory points comprising a starting trajectory point and an ending trajectory point;
determining whether the current trajectory point is the ending trajectory point of the second to-be-recognized trajectory points according to the determining condition, if the current trajectory point meets the determining condition, taking the current trajectory point as the ending trajectory point of the second to-be-recognized trajectory points, and taking trajectory points between the starting trajectory point and the ending trajectory point as the second to-be-recognized trajectory points;
recognizing the second to-be-recognized trajectory points by using the text recognition model to obtain a second text recognition result; and
displaying the second text recognition result in a form of print in a second display area.

In some embodiments, the displaying the second text recognition result in a form of print in a second display area comprises:
acquiring display information of the first display area, the display information comprising a size of a font and a coordinate; and
determining the second display area according to the display information, and displaying the second text recognition result in the form of print in the second display area, a size of a font in the second text recognition result being the same as the size of the font in the first text recognition result, a word in the second text recognition result being aligned with a word in the first text recognition result.

In some embodiments, the displaying the second text recognition result in a form of print in a second display area comprises:
determining whether the word in the second text recognition result is in the same row as the word in the first text recognition result; and
if the determining result is yes, displaying the word in the second text recognition result in the same row as the word in the first text recognition result.

In some embodiments, the determining whether the word in the second text recognition result is in the same row as the word in the first text recognition result comprises:
determining whether the word in the second text recognition result is in the same row as the word in the first text recognition result, according to a position coordinate of the word in the second text recognition result and a position coordinate of the word in the first text recognition result.

In some embodiments, the determining whether the word in the second text recognition result is in the same row as the word in the first text recognition result comprises:
determining whether a first space between the word in the second text recognition result and the word in the first text recognition result in a row direction of the text is less than a first threshold and whether a second space between the word in the second text recognition result and the word in the first text recognition result in a column direction of the text is less than a second threshold, according to the position coordinate of the word in the second text recognition result and the position coordinate of the word in the first text recognition result; and
determining that the word in the second text recognition result is in the same row as the word in the first text recognition result, in the case where the first space is less than the first threshold and the second space is less than the second threshold.

In some embodiments, the first threshold is in positive correlation with a width of the word in the second text recognition result; and/or
the second threshold is in positive correlation with a height of the word in the first text recognition result.

In some embodiments, the displaying the word in the second text recognition result in the same row as the word in the first text recognition result comprises:
setting a same label for the words displayed on the same row, the label reflecting information of the row where the word is located.

In a second aspect of the embodiments of the present disclosure, there is provided a handwriting recognition apparatus, comprising:
a detection module configured to detect information of a plurality of trajectory points corresponding to a handwritten trajectory of a user on a handwriting screen, the information comprising a coordinate, the plurality of trajectory points comprising a starting trajectory point and a current trajectory point;
a determining module configured to determine whether the current trajectory point is an ending trajectory point according to a determining condition, if the current trajectory point meets the determining condition, taking the current trajectory point as the ending trajectory point, and taking trajectory points between the starting trajectory point and the ending trajectory point as first to-be-recognized trajectory points;
a recognition module configured to recognize the first to-be-recognized trajectory points by using a text recognition model to obtain a first text recognition result; and
a display module configured to display the first text recognition result in a form of print in a first display area of the handwriting screen.

In some embodiments, the information further comprises a user writing state, which comprises pen-starting, pen-moving, or pen-lifting, the determining condition is that no new trajectory point is detected within a preset duration after a pen-lifting moment of the current trajectory point, and the starting trajectory point is a next trajectory point of a last trajectory point inputted to the text recognition model last time, or a first trajectory point of the handwriting screen.

In a third aspect of the embodiments of the present disclosure, there is provided an interactive display, comprising a touch module, a display module, a processor, a memory, and a program or instructions stored on the memory and executable on the processor, wherein the program or the instructions, when executed by the processor, implement the steps of the handwriting recognition method of the first aspect described above.

In a fourth aspect of the embodiments of the present disclosure, there is provided a readable storage medium having thereon stored a program or instructions, wherein the program or the instructions, when executed by a processor, implement the steps of the handwriting recognition method of the first aspect described above.

In a fifth aspect of the embodiments of the present disclosure, there is provided a handwriting recognition apparatus, comprising:
a memory; and
a processor coupled to the memory, the processor being configured to perform, based on instructions stored in the memory device, one or more steps of the handwriting recognition method of the first aspect described above.

Ina sixth aspect of the embodiments of the present disclosure, there is provided a handwriting recognition system, comprising the handwriting recognition apparatus of the fifth aspect described above, wherein the handwriting recognition apparatus comprises:
a first processor located on a server side and configured to recognize to-be-recognized trajectory points by using a text recognition model to obtain a text recognition result; and
a second processor located on a terminal side and configured to draw words comprised in the text recognition result one by one and store each word as one word trajectory.

In the embodiments of the present disclosure, after the handwritten trajectory is recognized in real-time, the text recognition result of the handwritten trajectory is displayed in real time in the form of print, thereby facilitating the user to view and correct the text recognition result in real time, so as to effectively improve the recognition rate and enhance the interactivity with the user.

### BRIEF DESCRIPTION OF THE DRAWINGS

Various other advantages and benefits will become apparent to one of ordinary skill in the art by reading the detailed description of preferred embodiments below. The accompanying drawings are only for the purpose of illustrating the preferred embodiments and are not to be construed as limiting the present disclosure. Moreover, identical reference numerals refer to identical components throughout the drawings. In the drawings:

FIG. 1 is a schematic flow diagram of a handwriting recognition method according to an embodiment of the present disclosure;

FIG. 2 is a comparison diagram of a handwritten trajectory and a text recognition result displayed on a handwriting screen according to an embodiment of the present disclosure;

FIG. 2A is a schematic diagram of a text erasure operation on a handwriting screen according to an embodiment of the present disclosure;

FIG. 2B is a comparison diagram of a handwritten trajectory and a text display result displayed on a handwriting screen according to an embodiment of the present disclosure;

FIG. 2C is a schematic diagram of a reference line for words-in-one-same-row determining according to an embodiment of the present disclosure;

FIG. 2D is a schematic diagram of performing one-same-row correction on jagged texts according to an embodiment of the present disclosure;

FIG. 2E is a schematic diagram of correcting a word rewritten after an erasure operation according to an embodiment of the present disclosure;

FIG. 3 is a schematic diagram of a handwriting recognition apparatus according to an embodiment of the present disclosure;

FIG. 4 is a schematic diagram of a structure of a handwriting recognition apparatus according to an embodiment of the present disclosure;

FIG. 5 is a block diagram of a handwriting recognition apparatus according to an embodiment of the present disclosure;

FIG. 6 is a block diagram illustrating a computer system for implementing an embodiment of the present disclosure.

### DETAILED DESCRIPTION

The technical solutions in the embodiments of the present disclosure will be clearly and completely described below in conjunction with the accompanying drawings in the embodiments of the present disclosure, and it is obvious that the described embodiments are only some of the embodiments of the present disclosure, but not all of them. All other embodiments, which can be derived by one of ordinary skill in the art from the embodiments in the present disclosure without making inventive efforts, are intended to fall within the scope of protection of the present disclosure.

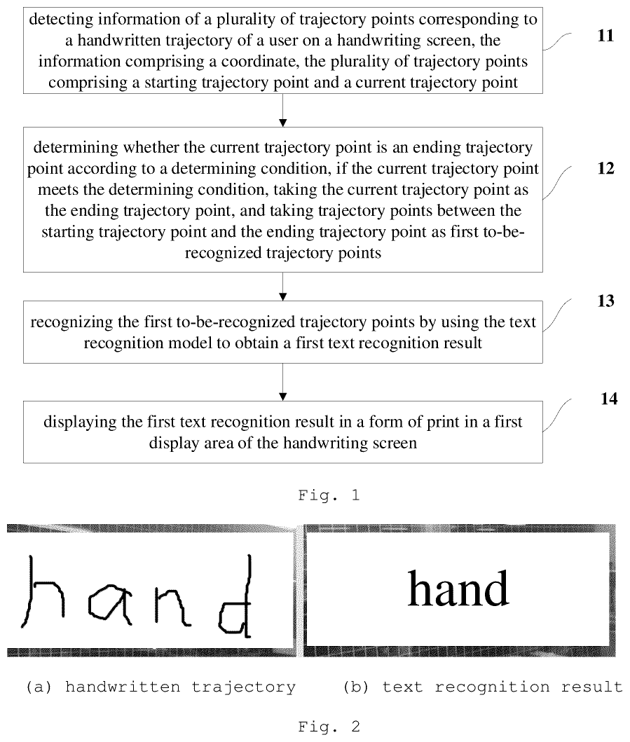

Referring to FIG. 1, in an embodiment of the present disclosure, there is provided a handwriting recognition method, comprising: steps 11 to 14.

Step 11: detecting information of a plurality of trajectory points corresponding to a handwritten trajectory of a user on a handwriting screen, the information comprising a coordinate, the plurality of trajectory points comprising a starting trajectory point and a current trajectory point. In some embodiments, the information further comprises a user writing state, which comprises pen-starting, pen-moving, or pen-lifting.

The handwriting screen can be a handwriting device such as an electronic conference whiteboard and the like and is provided with a touch module and a display module.

In an embodiment of the present disclosure, the trajectory points can comprise trajectory points of one or more characters, and the characters can be Chinese, English, or number.

In an embodiment of the present disclosure, an upper left corner of the handwriting screen can be taken as an origin, the extension from which from left to right is an X axis and the extension from which from up to down is a Y axis. Alternatively, a lower left corner of the handwriting screen can also be taken as an origin, the extension from which from left to right is an X axis and the extension from which from down to up is a Y axis. In the embodiment of the present disclosure, there is no limitation on the setting of the coordinate axes.

In an embodiment of the present disclosure, pen-starting refers to a first trajectory point of one stroke, pen-lifting refers to a last trajectory point of one stroke, and pen-moving refers to an intermediate trajectory point of one stroke.

In an embodiment of the present disclosure, alternatively, each trajectory point can be denoted as follows: (x, y, t, flag), where x and y denote position coordinates of each trajectory point, t is writing time of the trajectory point, and flag denotes a user writing state (pen-starting, pen-moving, or pen-lifting).

The current trajectory point refers to a last trajectory point handwritten by the user on the handwriting screen.

Step 12: determining whether the current trajectory point is an ending trajectory point according to a determining condition, if the current trajectory point meets the determining condition, taking the current trajectory point as an ending trajectory point, and taking trajectory points between the starting trajectory point and the ending trajectory point as first to-be-recognized trajectory points.

In some embodiments, the determining condition is that no new trajectory point is detected within a preset duration after a pen-lifting moment of the current trajectory point, and the starting trajectory point is a next trajectory point of a last trajectory point inputted to the text recognition model last time, or a first trajectory point of the handwriting screen. Here, “a last trajectory point” and “a next trajectory point” both refer to trajectory points inputted to the text recognition model. For example, trajectory points written in the case where a word recognition function is suspended does not belong to the trajectory points inputted to the text recognition model.

The first to-be-recognized trajectory points comprises the starting trajectory point and the ending trajectory point of the handwritten trajectory.

It should be appreciated that when a plurality of words are written in succession, a writing interval between the words does not exceed a threshold (for example, 500 ms or 2000 ms), otherwise it is considered that what is written is still a single word.

Step 13: recognizing the first to-be-recognized trajectory points by using a text recognition model to obtain a first text recognition result. The first text recognition result can comprise one word or a text paragraph comprising a plurality of words.

Step 14: displaying the first text recognition result in a form of print in a first display area of the handwriting screen.

In some embodiments, the plurality of words comprised in the first text recognition result are stored as word trajectories, wherein each word is stored as one word trajectory. In this way, processes such as drawing, modification, erasure, and the like, can be respectively performed on each word in the first text recognition result. For example, the plurality of words comprised in the first text recognition result are separately drawn one by one.

It should be understood that row division can also be performed on the first to-be-recognized trajectory points; and the plurality of words comprised in the first text recognition result are respectively drawn row by row according to a result of the row division. In this way, when an operation such as modification, erasure, and the like, is performed on the text in the first text recognition result, the processing of row division can be implemented. For example, the words comprised in the first text recognition result can be associated with a same label, and the label can comprise row information of the words. A label can be set for each trajectory point, each word trajectory or word.

Of course, the words comprised in the first text recognition result can also be wholly stored as one word trajectory and drawn as a whole. The word trajectory can be stored in a designated storage area. In this way, when an operation such as modification, erasure, and the like, is performed on the first text recognition result, the whole processing can be implemented. For example, the words comprised in the first text recognition result can be associated with a same label, and the label can comprise time information, paragraph information, or batch information of the words.

For the print, for example, standard text such as SimSun, KaiTi, SimHei, or the like, is employed for Chinese, and standard text such as Times New Roman, or the like, is employed for English and number, so as to be distinguished from the handwritten trajectory.

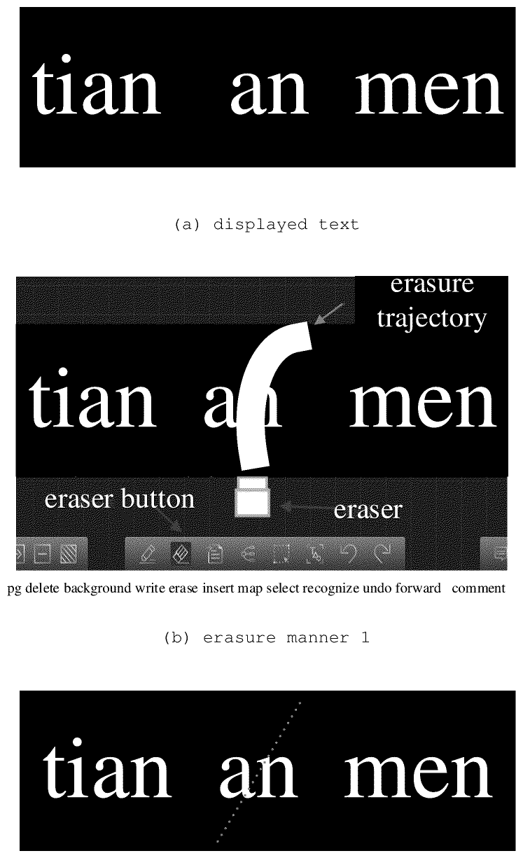

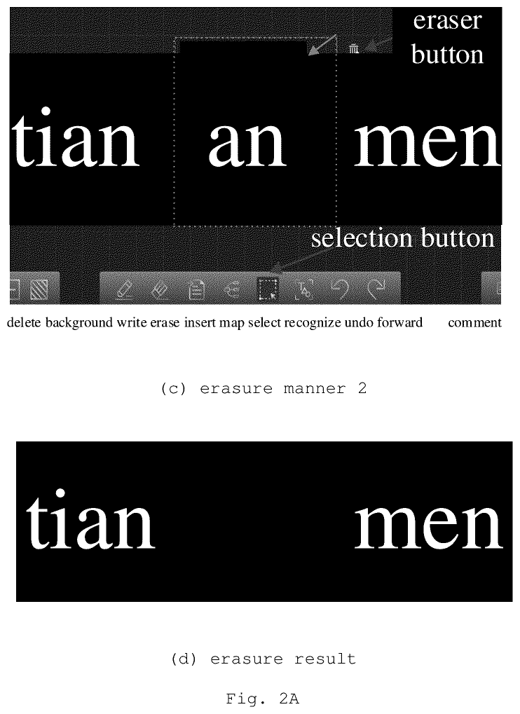

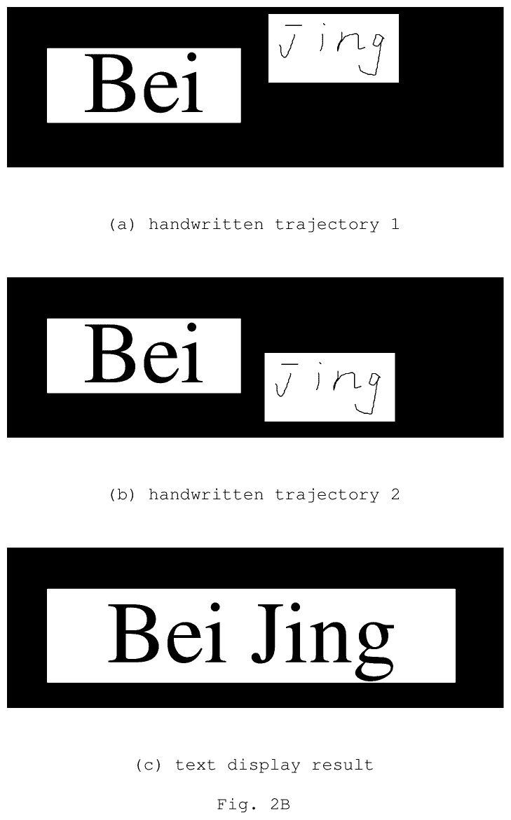

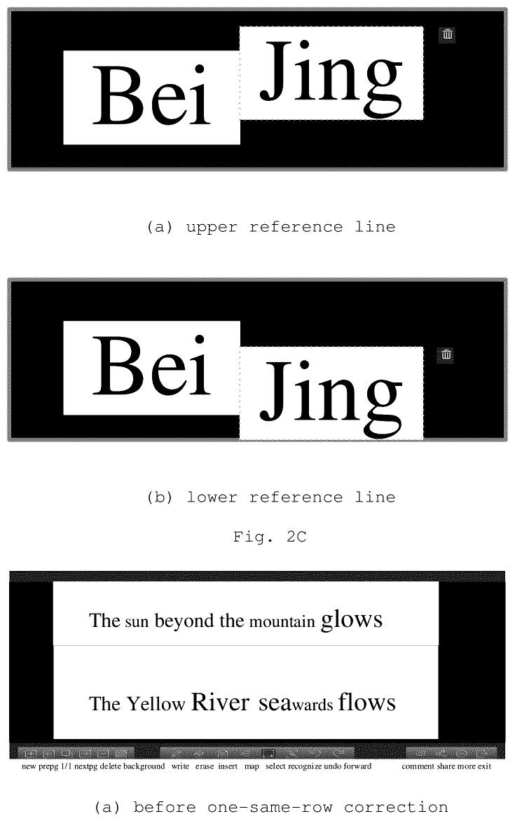

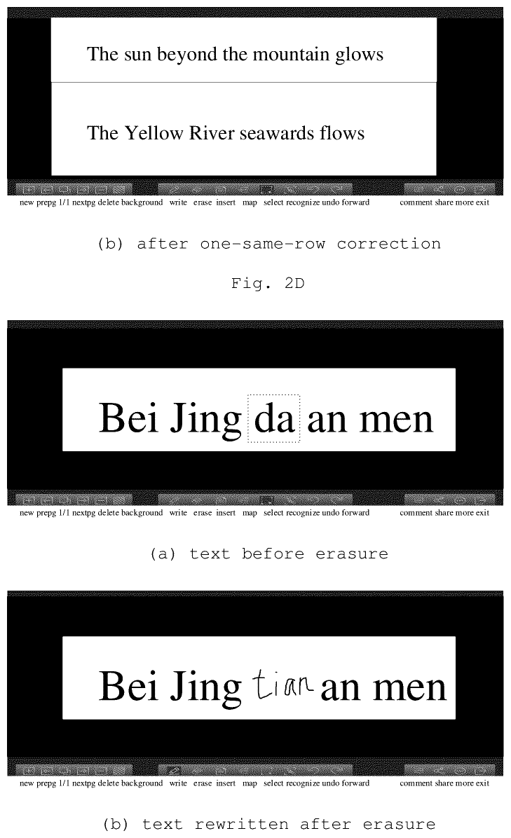

Please refer to FIG. 2, which is a comparison diagram of a handwritten trajectory and a text recognition result displayed on a handwriting screen according to an embodiment of the present disclosure.

In an embodiment of the present disclosure, after the handwritten trajectory is recognized in real time, the text recognition result of the handwritten trajectory is displayed in real time in the form of print, thereby facilitating the user to view and correct the text recognition result in real time, so as to effectively improve the recognition rate and enhance the interactivity with the user.

Since what is received by the text recognition model is coordinates of many trajectory points which are arranged according to a writing time order without row division, and the text recognition model performs recognition according to row-by-row text trajectory points, it is needed to first perform row division on all the trajectory points; if the user writes a plurality of rows, row division is required for the trajectory points, and if the user only writes one row, row division is not required. That is, in the embodiment of the present disclosure, before the information of the first to-be-recognized trajectory points is recognized by using the text recognition model, row division can also be performed on the first to-be-recognized trajectory points. In some embodiments, a label comprising row information of words is set according to the row division result.

In an embodiment of the present disclosure, row division can be performed on the first to-be-recognized trajectory points by using a projection method. That is, performing row division on the first to-be-recognized trajectory points comprises:
step 21: acquiring the number of X-axis coordinate values of the first to-be-recognized trajectory points corresponding to each Y-axis coordinate value of the first to-be-recognized trajectory points; and
step 22: performing row division on the first to-be-recognized trajectory points according to the number of the X-axis coordinate values on the Y axis.

That is, the number of the X-axis coordinate values of all the trajectory points in the first to-be-recognized trajectory points is projected onto the Y axis. If there are too many words in one row, i.e., too many trajectory points, the number of the X-axis coordinate values on the Y axis will be larger; and if there is row division in the handwritten trajectory, the number of the X-axis coordinate values on the Y axis at a blank position in front and back two rows will be smaller or 0, that is, there will be a trough, whose value is taken as a basis for the row division.

However, if the words corresponding to the first to-be-recognized trajectory points written by the user are inclined, it will be inaccurate at this time if row division on the first to-be-recognized trajectory points is performed according to the above projection method. Therefore, alternatively, in the embodiment of the present disclosure, before row division is performed on the first to-be-recognized trajectory points, the method can further comprise:
determining whether the handwritten trajectory corresponding to the first to-be-recognized trajectory points is inclined; and
if the handwritten trajectory corresponding to the first to-be-recognized trajectory points is inclined, performing inclination correction on the coordinates of the first to-be-recognized trajectory points to obtain the corrected coordinates.

Since the coordinate values of the to-be-recognized trajectory points can range from 0 to thousands or tens of thousands, the influence of orders of magnitude is eliminated in order to facilitate calculation.

In other embodiments, the performing row division on the first to-be-recognized trajectory points can further comprise: dividing the first to-be-recognized trajectory points into the plurality of words according to the information of each trajectory point in the first to-be-recognized trajectory points; and determining whether two adjacent words are in a same row, wherein the two adjacent words comprise a first word written earlier and a second word written later.

It is determined whether the two adjacent words are in the same row according to a height and a position coordinate of the second word and a height and a position coordinate of the first word. For example, it is determined whether a first difference between an abscissa of a left edge of the second word and an abscissa of a right edge of the first word is less than a first threshold; it is determined whether a second difference between an ordinate of a top edge of the second word and an ordinate of a top edge of the first word is less than a second threshold; and in the case where the first difference is less than the first threshold and the second difference is less than the second threshold, it is determined that the second word and the first word are in the same row.

The first threshold is in positive correlation with a width of the second word, for example, the first threshold is half of the width of the second word. The second threshold is in positive correlation with a height of the first word, for example, the second threshold is half of the height of the first word.

In an embodiment of the present disclosure, alternatively, before recognizing the information of the first to-be-recognized trajectory points by using the text recognition model to obtain the first text recognition result, the method further comprises: normalizing the coordinates of the first to-be-recognized trajectory points into a same numerical range, for example, into (0, 1).

In an embodiment of the present disclosure, text recognition on the information of the first to-be-recognized trajectory points can be performed by using a Seq2Seq network. Of course, in other embodiments of the present disclosure, other text recognition models, for example, a RNN network, and the like, can be employed.

In an embodiment of the present disclosure, alternatively, after recognizing the information of the first to-be-recognized trajectory points by using the text recognition model to obtain the first text recognition result, the method further comprises: performing semantic correction on the first text recognition result. For example, the semantic correction can comprise: Chinese semantic correction and/or English semantic correction, and when there is an incorrectly recognized letter in a single English word, the incorrect letter is corrected according to context semantic information.

Since users have a very high degree of freedom when writing on the electronic whiteboard, some users preferring to write on a right half of the electronic whiteboard first and then write on a left half, some users preferring to write on a middle area first and then write on an upper half or a lower half. The related handwriting recognition method is that recognition is performed according to the time sequence of the writing by the user and the recognition result is once written into a document, in which storage is also performed according to the recognition sequence without considering the spatial position relation of the typesetting of the original handwritten trajectory. This results in the user needing to find the position of the original handwritten trajectory according to the recognition result if the original handwritten trajectory is written in a random order, when the user compares the recognition result with the original handwritten trajectory, and thus it is very inconvenient.

In order to solve the above problem, in the embodiment of the present disclosure, alternatively, the displaying the first text recognition result in a first display area in a form of print comprises:
step 31: removing the handwritten trajectory corresponding to the first to-be-recognized trajectory points on the handwriting screen;
step 32: determining the first display area according to the coordinates of the first to-be-recognized trajectory points; and
step 33: displaying the first text recognition result in the form of print in the first display area.

In the embodiment of the present disclosure, after the handwritten trajectory is recognized, the handwritten trajectory on the handwriting screen is erased in real time, and the text recognition result of the handwritten trajectory is displayed in real time in the form of print in the area where the handwritten trajectory is located, thereby further facilitating the user to view and correct the text recognition result in real time.

In an embodiment of the present disclosure, alternatively, the determining the first display area according to the coordinates of the first to-be-recognized trajectory points comprises:
step 41: acquiring a minimum X-axis coordinate, a minimum Y-axis coordinate, a maximum X-axis coordinate and a maximum Y-axis coordinate, i.e., xₘᵢₙ, yₘᵢₙ, xₘₐₓ, yₘₐₓ, in the first to-be-recognized trajectory points; and
step 42: determining a first rectangular box according to the minimum X-axis coordinate, the minimum Y-axis coordinate, the maximum X-axis coordinate and the maximum Y-axis coordinate in the first to-be-recognized trajectory points, and taking the first rectangular box as the first display area.

However, if the words corresponding to the first to-be-recognized trajectory points written by the user are inclined, the first display area is, at this time, an inclined rectangular box if the first display area is determined according to the original coordinates of the first to-be-recognized trajectory points. In an embodiment of the present disclosure, alternatively, the determining the first display area according to the coordinates of the first to-be-recognized trajectory points comprises:
step 401: determining whether the handwritten trajectory corresponding to the first to-be-recognized trajectory points is inclined;
step 402: if the handwritten trajectory corresponding to the first to-be-recognized trajectory points is inclined, performing inclination correction on the coordinates of the first to-be-recognized trajectory points to obtain corrected coordinates; and
step 403: determining the first display area according to the corrected coordinates.

In an embodiment of the present disclosure, alternatively, a method of performing inclination correction on the coordinates of the first to-be-recognized trajectory points can be as follows: first, one rectangular box can be determined according to the original coordinates of the first to-be-recognized trajectory points, and then, one point is determined as a rotation center of the rectangular box to rotate the rectangular box, wherein the rotation center can be a center point of the rectangular box or another point.

According to the corrected coordinates, the first rectangular box is determined in the manner of the steps 41 and 42 as the first display area. That is to say, the minimum X-axis coordinate, the minimum Y-axis coordinate, the maximum X-axis coordinate, and the maximum Y-axis coordinate in the steps 41 and 42 are all the corrected coordinates.

In an embodiment of the present disclosure, alternatively, the displaying the first text recognition result in the form of print in the first display area comprises:
determining a size of a font of the first text recognition result according to a size of the first display area;
determining a word space of the first text recognition result according to the size of the font of the first text recognition result; and
displaying the first text recognition result in the first display area with the determined size of the font and the determined word space.

In an embodiment of the present disclosure, alternatively, a correspondence relation between the font and the word space can be stored in advance, and when the size of the font is determined, the word space is also determined. Of course, a manner in which the word space can be determined according to the size of the first display area is not excluded.

In an embodiment of the present disclosure, alternatively, after displaying the first text recognition result in the form of print in the area where the handwritten trajectory is located, the method further comprises:
step 51: receiving an erasure operation of the user on a target text in the first text recognition result, and erasing the target text.

In some embodiments, the erasure operation comprises selecting the target text. For example, after the target text is selected, the target text can be erased by clicking a deletion/erasure button.

In some other embodiments, a corresponding erasure operation can be performed according to an erasure gesture of the user. For example, after an erasure function is selected, a word trajectory intersected with an erasure trajectory is deleted. Alternatively, through the erasure gesture, for example, a palm touching the display panel to generate an eraser sign, the user deletes a word trajectory intersected with a trajectory of hand movement. The erasure gesture can be, for example, a flat ellipse gesture, a polyline, a zigzag, a reverse N, a cross, etc., as long as it does not affect the writing. It should be understood that the corresponding relation between the erasure gesture and the erasure operation can be set according to actual needs. Partial or complete erasure on the text recognition result can be performed by the user. After the erasure operation, the user can rewrite.

For the partial erasure, as described above, each word comprised in the first text recognition result is separately stored as one word trajectory, so that only the word trajectory intersected with the trajectory of the erasure gesture can be deleted. That is, in some embodiments, according to a first erasure gesture of the user, the word trajectory intersected with the trajectory of the first erasure gesture is erased.

Please refer to FIG. 2A, which is a schematic diagram of a text erasure operation on a handwriting screen according to an embodiment of the present disclosure.

FIG. 2A (a) is text displayed on the handwriting screen. FIG. 2A (b) shows a schematic diagram of an erasure manner 1. FIG. 2A (c) shows a schematic diagram of an erasure manner 2. FIG. 2A (d) shows an erasure result.

For the erasure manner shown in FIG. 2A (b), after an erasure switch is activated, when a drawing board on the handwriting screen is touched by the user, an eraser icon will appear at a contact point, for example, the eraser is a drawing pen that is transparent; in a process of movement on the drawing board, the eraser draws, on the drawing board, an erasure trajectory, namely an erasure gesture; and when the erasure gesture is finished, for example, after a finger of the user leaves the screen, according to the trajectory of the erasure gesture, a word trajectory intersected with the trajectory will be erased from the drawing board, as shown in FIG. 2A (d). At the same time, the word trajectory intersected with the trajectory will also be removed from a designated storage area.

For the erasure manner shown in FIG. 2A (c), in an element area selection mode, a trajectory of a finger of the user touching the screen can form one dashed line, i.e., erasure gesture, which is intersected with a word; when the erasure gesture is finished, for example, when the finger of the user leaves the screen, a rectangular box and a deletion button will appear; after the deletion button is clicked, a word trajectory intersected with the trajectory is erased from the drawing board, as shown in FIG. 2A (d). At the same time, the word trajectory intersected with the trajectory will also be removed from a designated storage area.

For the partial deletion, in other embodiments, according to a second erasure gesture of the user, a word trajectory intersected with a trajectory of the second erasure gesture is erased, and a word trajectory having the same label as the word trajectory is erased. The label here is a first label, which comprises row information of the word trajectory. That is, the word trajectory intersected with the trajectory of the second erasure gesture can be erased, and a word trajectory belonging to the same row as the word trajectory is erased. Similarly, these erased word trajectories will be cleared from the drawing board and at the same time will also be removed from designated storage areas.

For the complete deletion, as described above, the words comprised in the first text recognition result can be associated with the same label, so that the overall deletion of all the words comprised in the first text recognition result can be conveniently implemented by deleting the word trajectory intersected with the trajectory of the erasure gesture. The label here is a second label, which comprises time information, paragraph information or batch information of the word trajectory. That is, the word trajectory intersected with the trajectory of the second erasure gesture can be erased, and handwritten word trajectories belonging to the same time period, the same paragraph, or the same batch as the word trajectory are erased.

In the above embodiment, by drawing each word individually and storing the word trajectory individually, different erasure operations performed according to different erasure gestures can be conveniently implemented, for example, only the word trajectory intersected with the trajectory of the erasure gesture can be deleted, or both the word trajectory intersected with the trajectory of the erasure gesture and the word trajectories in the same row thereof can be deleted, or both the word trajectory intersected with the trajectory of the erasure gesture and the handwritten word trajectories in the same time period, the same paragraph, or the same batch thereof can be deleted.

In addition, it should be understood that, regardless of whether the erasure operation is performed, the writing of a word can be continued after the first text recognition result is displayed in the form of print. Accordingly, processes such as detection, determining, recognition, display, and the like, similar to the first to-be-recognized trajectory points, can be performed on to-be-recognized trajectory points corresponding to a handwritten trajectory which is continuously written. That is, the handwriting recognition method further comprises step 52 to step 55.

Step 52: detecting information of second to-be-recognized trajectory points corresponding to a handwritten trajectory of the user on the handwriting screen, the information comprising a coordinate, time and a user writing state, the user writing state comprising pen-starting, pen-moving and pen-lifting, the second to-be-recognized trajectory points comprising a starting trajectory point and an ending trajectory point.

In an embodiment of the present disclosure, in the step S52, the user can rewrite in the erasure area, or in another position. That is, in the step S52, information of the second to-be-recognized trajectory points corresponding to a handwritten trajectory rewritten by the user is detected, the information comprising a coordinate, time, and a user writing state, the user writing state comprising: pen-starting, pen-moving and pen-lifting; the second to-be-recognized trajectory points comprising a starting trajectory point and an ending trajectory point.

Of course, in an embodiment of the present disclosure, the user can also write at another position without performing the erasure operation. Step 53: determining whether a current trajectory point is the ending trajectory point of the second to-be-recognized trajectory points according to the determining condition, if the current trajectory point meets the determining condition, taking the current trajectory point as the ending trajectory point of the second to-be-recognized trajectory points, and taking trajectory points between the starting trajectory point and the ending trajectory point as the second to-be-recognized trajectory points.

In some embodiments, the determining condition is that no new trajectory point is detected within a preset duration after a pen-lifting moment of the current trajectory point and the starting trajectory point is a next trajectory point of a last trajectory point inputted to the text recognition model last time.

Step 54: recognizing the second to-be-recognized trajectory points by using the text recognition model to obtain a second text recognition result.

Before the second to-be-recognized trajectory points are recognized, processes such as row division and/or normalization can also be performed on the second to-be-recognized trajectory points. Please refer to the processing on the first to-be-recognized trajectory points described above, which is not described one by one here. Similarly, after the second to-be-recognized trajectory points are recognized, semantic correction processing can also be performed.

Step 55: displaying the second text recognition result in a form of print in a second display area.

For the print, for example, SimSun, KaiTi, SimHei, or the like, is employed for Chinese, and Times New Roman, or the like, is employed for English and number, so as to be distinguished from the handwritten trajectory, and alternatively, the print is the same as the print employed for the first text recognition result.

In an embodiment of the present disclosure, after the handwritten trajectory is recognized, the handwritten trajectory on the handwriting screen is erased in real time, and the recognition result of the handwritten trajectory is displayed in real time in the form of print in an area where the handwritten trajectory is located, thereby facilitating the user to view, check and correct the recognition result in real time and improving the interactivity with the user.

In an embodiment of the present disclosure, it is supported that erasure and rewriting are performed many times by the user.

In an embodiment of the present disclosure, alternatively, the displaying the second text recognition result in a form of print in a second display area comprises:
step 61: acquiring a minimum X-axis coordinate, a minimum Y-axis coordinate, a maximum X-axis coordinate and a maximum Y-axis coordinate in the second to-be-recognized trajectory points; and
step 62: determining a second rectangular box according to the minimum X-axis coordinate, the minimum Y-axis coordinate, the maximum X-axis coordinate and the maximum Y-axis coordinate in the second to-be-recognized trajectory points, and taking the second rectangular box as the second display area.

Similarly, before the displaying the second text recognition result in a form of print in a second display area, the method can further comprise:
step 71: determining whether the handwritten trajectory corresponding to the second recognition trajectory points is inclined;
step 72: if the handwritten trajectory corresponding to the second recognition trajectory points is inclined, performing inclination correction on the coordinates of the second to-be-recognized trajectory points to obtain corrected coordinates; and

Step 73: determining the second display area according to the corrected coordinates.

For example, on the basis of the corrected coordinates, the second display area is determined according to the steps 61 and 62 described above.

In an embodiment of the present disclosure, alternatively, the displaying the second text recognition result in a form of print in a second display area comprises:
step 81: acquiring display information of the first text recognition result, the display information comprising a size of a font and a coordinate; and step 82: determining the second display area according to the display information, and displaying the second text recognition result in the form of print in the second display area. A size of a font in the second text recognition result is the same as the size of the font in the first text recognition result, and a word in the second text recognition result is aligned with a word in the first text recognition result.

In the step 81, the display information of the first display area is acquired. In the step 82, it should be appreciated that: due to difference in fonts of different words, “same size of fonts” means substantially the same, but does not strictly limit the same in both width and height; “words aligned” also means that substantially aligned, but does not strictly limit aligned in both row and column directions.

In some embodiments, the step 82 comprises: step 821, determining whether a word in the second text recognition result and a word in the first text recognition result are in a same row; and step 822, if the determining result is yes, displaying the word in the second text recognition result and the word in the first text recognition result in the same row. It should be understood that, only in the case where a distance (comprising a distance in a row direction and a distance in a column direction) between the second display area and the first display area is close, it is determined whether the word in the second text recognition result and the word in the first text recognition result are in the same row.

In the step 821, it can be determined whether a first space between the word in the second text recognition result and the word in the first text recognition result in a row direction of the text is less than a first threshold and a second space between the word in the second text recognition result and the word in the first text recognition result in a column direction of the text is less than a second threshold, according to a position coordinate of the word in the second text recognition result and a position coordinate of the word in the first text recognition result; and in the case where the first space is less than the first threshold and the second space is less than the second threshold, it is determined that the word in the second text recognition result is in the same row with the word in the first text recognition result.

In the case where the word in the second text recognition result is on a right side of the word in the first text recognition result, the first space in the row direction of the text can be characterized by a difference between an abscissa of a left edge of the word in the second text recognition result and an abscissa of a right edge of the word in the first text recognition result.

Similarly, in the case where the word in the second text recognition result is on a left side of the word in the first text recognition result, the first space in the row direction of the text can be characterized by a difference between an abscissa of a right edge of the word in the second text recognition result and an abscissa of a left edge of the word in the first text recognition result.

The first threshold can also be determined according to size and position relations between the words. The first threshold can also be in positive correlation with a width of the word in the second text recognition result, for example, it can be half of the width of the word in the second text recognition result.

The second space in the column direction of the text can be characterized by a difference between an ordinate of a top edge of the word in the second text recognition result and an ordinate of a top edge of the word in the first text recognition result.

The second threshold is in positive correlation with a height of the word in the first text recognition result, for example, it can be half of the height of the word in the first text recognition result.

In the above embodiment, when there have already been some words on the drawing board, that is, after the first text recognition result has been displayed in the form of print in the first display area, when a new word is written, a display area for the newly written word, which comprises information such as a starting position, a size of the word, and the like, can be determined according to boundary information of the existing word, for example, information such as upper left and lower right of the word. Therefore, the display of the later written word can be corrected according to the earlier displayed word.

Please refer to FIG. 2B, which is a comparison diagram of a handwritten trajectory and a text display result displayed on a handwriting screen according to an embodiment of the present disclosure.

It can be seen that, in (c) of FIG. 2B, the text display result shows that according to a word “Bei” displayed earlier, correction display on a word “Jing” written later in handwritten trajectories 1 and 2 in (a) and (b) of FIG. 2B.

In addition, for words-in-one-same-row determining, a reference line can be set, as shown in FIG. 2C. FIG. 2C is a schematic diagram of a reference line for words-in-one-same-row determining according to an embodiment of the present disclosure. FIG. 2c (a) and (b) show upper and lower reference lines, respectively.

In the case where there are, in the row direction, earlier displayed words on both left and right sides of a later written word, the earlier displayed word on either side is taken as a reference to determine whether the later written word and the earlier displayed word are in one same row.

Through the above embodiment, at least one of the following problems can be solved: since the position and the size of the font are non-uniform when writing each time, problems such as non-uniform sizes and placement positions of words of the recognized standard text, or a phenomenon of words overlapped occur; or, problems such as position or size deviation between new words and existing words occur when writing is performed again at a same position after a part of words (i.e., the target text) in the first text recognition result is erased.

FIG. 2D shows a schematic diagram of one-same-row correction for jagged texts +according to an embodiment of the present disclosure. FIG. 2D (a) and (b) show texts before and after one-same-row correction, respectively.

FIG. 2E shows a schematic diagram of correcting a word rewritten after an erasure operation according to an embodiment of the present disclosure. FIG. 2E (a), (b), and (c) show text before erasure, text rewritten after erasure, and text displayed after correction, respectively. It can be seen that, through some embodiments of the present disclosure, recognized handwritten words can be displayed according to standard text patterns (such as print), and standard arrangement can be performed on the texts, so that each word in the displayed text is in an uniform format. In addition, in some embodiments of the present disclosure, it can also be supported that, the display of the rewritten text after modification is kept in uniform typesetting with the earlier written and displayed text, without the case where the word rewritten after the erasure is in disordered typesetting with the early written and displayed text.

In some embodiments, a same label can also be set for the words displayed in the same row, the label reflecting information of the row where the words are located. In this way, even if handwritten words belong to different batches, the words can still be erased row by row according to a corresponding erasure gesture as long as they are displayed in a same row.

Similarly, in the case where the words comprised in the first text recognition result are respectively drawn row by row, the target text can be erased according to the erasure operation of the user on the target text in the first text recognition result, and the word trajectory belonging to the same row as the target text is erased.

In an embodiment of the present disclosure, alternatively, a correspondence relation between a font and a word space can be stored in advance, and when a size of the font is determined, the word space is also determined. Of course, a manner in which the word space can be determined according to the size of the second display area is not excluded.

According to the above display method, the display effect of the text recognition result can be improved.

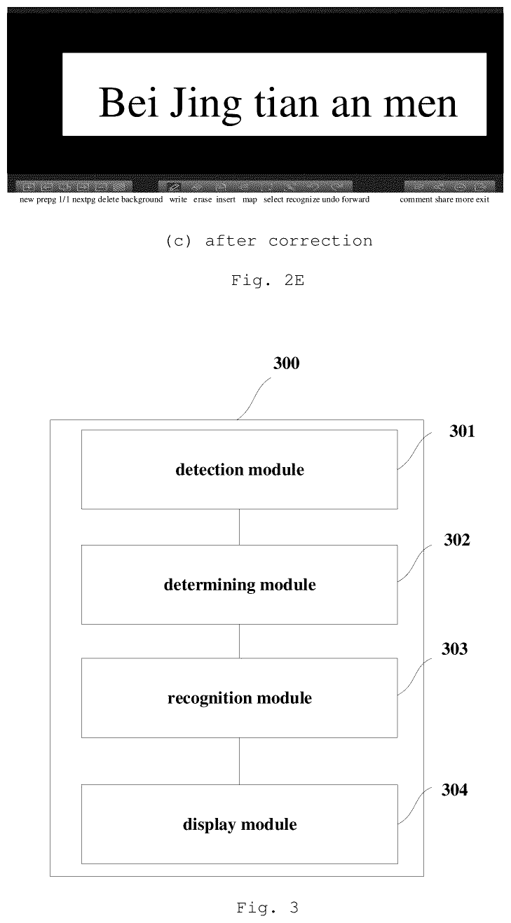

Referring to FIG. 3, in an embodiment of the present disclosure, there is further provided a handwriting recognition apparatus 300, comprising:
a detection module 301 configured to detect information of a plurality of trajectory points corresponding to a handwritten trajectory of a user on a handwriting screen, the information comprising a coordinate, time and a user writing state, the user writing state comprising: pen-lifting, pen-moving, and pen-lifting; the plurality of trajectory points comprising a starting trajectory point and a current trajectory point;
a determining module 302 configured to determine whether the current trajectory point is an ending trajectory point according to a determining condition, if the current trajectory point meets the determining condition, take the current trajectory point as the ending trajectory point, and take trajectory points between the starting trajectory point and the ending trajectory point as first to-be-recognized trajectory points, the determining condition being that no new trajectory point is detected within a preset duration after a pen-lifting moment of the current trajectory point, the starting trajectory point being a next trajectory point of a last trajectory point inputted to a text recognition model last time, or a first trajectory point of the handwriting screen;
a recognition module 303 configured to recognize the first to-be-recognized trajectory points by using the text recognition model to obtain a first text recognition result;
a display module 304 configured to display the first text recognition result in a form of print in a first display area of the handwriting screen.

In an embodiment of the present disclosure, after the handwritten trajectory is recognized in real time, the text recognition result of the handwritten trajectory is displayed in real time in the form of print, thereby facilitating the user to view and correct the text recognition result in real time, so as to effectively improve the recognition rate and enhance the interactivity with the user.

In an embodiment of the present disclosure, alternatively, the handwriting recognition apparatus further comprises at least one of :
a row division module configured to perform row division on the first to-be-recognized trajectory points; or
a normalization module configured to normalize coordinates of the first to-be-recognized trajectory points into a same numerical range.

In an embodiment of the present disclosure, alternatively, the row division module is configured to acquire the number of X-axis coordinate values of the first to-be-recognized trajectory points corresponding to each Y-axis coordinate value of the first to-be-recognized trajectory points; and perform row division on the first to-be-recognized trajectory points according to the number of the X-axis coordinate values on a Y axis.

In an embodiment of the present disclosure, alternatively, the handwriting recognition apparatus further comprises:
a semantic recognition module configured to perform semantic recognition on the first text recognition result, and perform semantic correction if the first text recognition result has a semantic error.

In an embodiment of the present disclosure, alternatively, the display module is configured to remove the handwritten trajectory corresponding to the first to-be-recognized trajectory points on the handwriting screen; determine a first display area according to the coordinates of the first to-be-recognized trajectory points; and display the first text recognition result in the form of print in the first display area.

In an embodiment of the present disclosure, alternatively, the display module is configured to acquire a minimum X-axis coordinate, a minimum Y-axis coordinate, a maximum X-axis coordinate, and a maximum Y-axis coordinate of the first to-be-recognized trajectory points; and
determine a first rectangular box according to the minimum. X-axis coordinate, the minimum Y-axis coordinate, the maximum X-axis coordinate and the maximum Y-axis coordinate in the first to-be-recognized trajectory points, and take the first rectangular box as the first display area.

In an embodiment of the present disclosure, alternatively, the display module is further configured to determine whether the handwritten trajectory corresponding to the first to-be-recognized trajectory points is inclined; if the handwritten trajectory corresponding to the first to-be-recognized trajectory points is inclined, perform inclination correction on the coordinates of the first to-be-recognized trajectory points to obtain corrected coordinates; and determine the first display area according to the corrected coordinates.

In an embodiment of the present disclosure, alternatively, the display module is further configured to determine a size of a font of the first text recognition result according to a size of the first display area; determine a word space of the first text recognition result according to the size of the font of the first text recognition result; and display the first text recognition result in the first display area according to the determined size of the font and the determined word space.

In an embodiment of the present disclosure, alternatively, the handwriting recognition apparatus further comprises:
an erasure module configured to receive an erasure operation of the user on a target text in the first text recognition result and erase the target text;
wherein the detection module is further configured to detect information of second to-be-recognized trajectory points corresponding to a handwritten trajectory rewritten by the user, the information comprising a coordinate, time and a user writing state, the user writing state comprising: pen-starting, pen-moving and pen-lifting; the second to-be-recognized trajectory points comprising a starting trajectory point and an ending trajectory point;
the determining module is further configured to determine whether a current trajectory point is an ending trajectory point of the second to-be-recognized trajectory points according to the determining condition, if the current trajectory point meets the determining condition, take the current trajectory point as the ending trajectory point of the second to-be-recognized trajectory points, and take trajectory points between the starting trajectory point and the ending trajectory point as the second to-be-recognized trajectory points, the determining condition being that no new trajectory point is detected within a preset duration after a pen-lifting moment of the current trajectory point, the starting trajectory point being a next trajectory point of a last trajectory point inputted to the text recognition model last time;
the recognition module is further configured to recognize the second to-be-recognized trajectory points by using the text recognition model to obtain a second text recognition result; and
the display module is further configured to display the second text recognition result in a form of print in a second display area.

In an embodiment of the present disclosure, alternatively, the display module is further configured to acquire a minimum X-axis coordinate, a minimum Y-axis coordinate, a maximum X-axis coordinate, and a maximum Y-axis coordinate in the second to-be-recognized trajectory points; and determine a second rectangular box according to the minimum X-axis coordinate, the minimum Y-axis coordinate, the maximum X-axis coordinate and the maximum Y-axis coordinate in the second to-be-recognized trajectory points, and take the second rectangular box as the second display area.

In an embodiment of the present disclosure, alternatively, the display module is further configured to acquire display information of the first text recognition result, the display information comprising a size of a font and a coordinate; and determine the second display area according to the display information, and display the second text recognition result in the form of print in the second display area, a size of a font in the second text recognition result being the same as the size of the font in the first text recognition result, a word in the second text recognition result being aligned with a word in the first text recognition result.

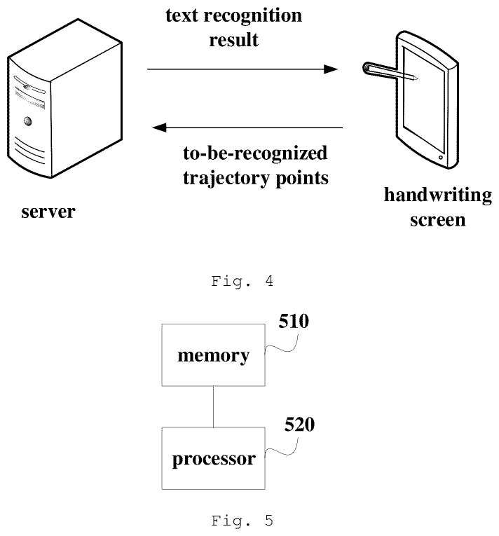

In an embodiment of the present disclosure, the above function modules can be integrated into one entity device, or can be disposed in a plurality of entity devices. For example, the detection module configured to detect information of trajectory points corresponding to the handwritten trajectory of the user on the handwriting screen and the display module configured to display the text recognition result in a form of print can be disposed on the handwriting screen which can be referred to as a front end at this time, and the recognition module configured to recognize information of the to-be-recognized trajectory points by using the text recognition model to obtain the text recognition result can be disposed on a server which can also be referred to as a back end at this time. See FIG. 4, where the information of the trajectory points detected by the handwriting screen is sent to the server, and the server recognizes the information of the trajectory points to obtain the text recognition result, and sends the text recognition result to the handwriting screen, and the text recognition result is displayed by the handwriting screen.

In an embodiment of the present disclosure, there is further provided an interactive display, comprising a touch module, a display module, a processor, a memory, and a program or instructions stored on the memory and executable on the processor, wherein the program or instructions, when executed by the processor, implement each process of the handwriting recognition method embodiments, and same technical effects can be achieved, which will not be repeated here in order to avoid repetition.

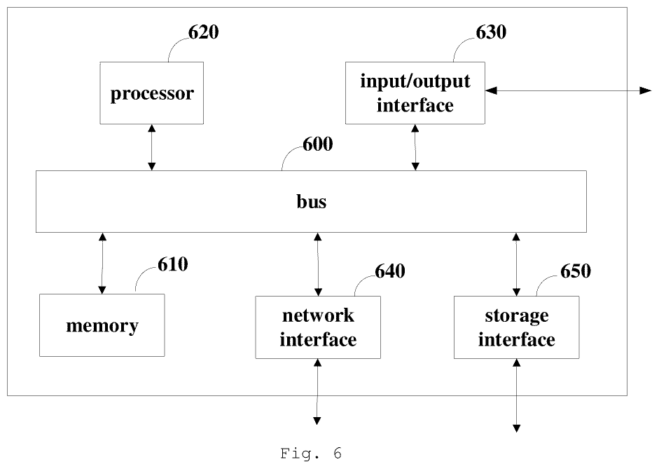

In an embodiment of the present disclosure, there is further provided a handwriting recognition apparatus, as shown in FIG. 5. The handwriting recognition apparatus comprises: a memory 510; and a processor 520 coupled to the memory 510, the processor being configured to perform, based on instructions stored in the memory, one or more steps of the handwriting recognition method according to any of the embodiments of the present disclosure.

In an embodiment of the present disclosure, there is further provided a handwriting recognition system, comprising the handwriting recognition apparatus described in the above embodiment, wherein the handwriting recognition apparatus comprises: a first processor located on a server side and configured to recognize to-be-recognized trajectory points by using a text recognition model to obtain a text recognition result; and a second processor located on a terminal side and configured to draw words comprised in the text recognition result one by one and store each word as one word trajectory.

In an embodiment of the present disclosure, there is further provided a readable storage medium having thereon stored a program or instructions, wherein the program or instructions, when executed by a processor, implement each process of the handwriting recognition method embodiments, and same technical effects can be achieved, which will not be repeated here in order to avoid repetition.

The processor is the processor in the terminal described in the above embodiment. The readable storage medium comprises a computer-readable storage medium, such as a computer read-only memory (ROM), a random access memory (RAM), a magnetic disk, an optical disk, or the like.

FIG. 6 is a block diagram illustrating a computer system for implementing some embodiments of the present disclosure.

As shown in FIG. 6, the computer system can be embodied in a form of a general-purpose computing device, and can be configured to implement the handwritten text recognition apparatus in the above embodiment. The computer system comprises a memory 610, a processor 620, and a bus 600 connecting different system components.

The memory 610 can comprise, for example, a system memory, a non-volatile storage medium, and the like. The system memory has thereon stored, for example, an operating system, an application, a boot loader, other programs, and the like. The system memory can comprise a volatile storage medium, such as a random access memory (RAM) and/or cache memory. The non-volatile storage medium has thereon stored, for example, instructions of the corresponding embodiment for performing the display method. The non-volatile storage medium includes, but is not limited to, a magnetic disk memory, an optical memory, a flash memory, and the like.

The processor 620 can be implemented by means of a discrete hardware component such as a general-purpose processor, digital signal processor (DSP), application specific integrated circuit (ASIC), field programmable gate array (FPGA) or other programmable logic device, discrete gate or transistor, and the like. Accordingly, each device, such as the determining device and the determination device, can be implemented by a central processing unit (CPU) running the instructions that are in the memory for performing the corresponding steps, or can be implemented by a dedicated circuit performing the corresponding steps.

The bus 600 can use any of a variety of bus architectures. For example, the bus architectures include, but are not limited to, an industry standard architecture (ISA) bus, a micro channel architecture (MCA) bus, and a peripheral component interconnect (PCI) bus.

The computer system can also comprise an input/output interface 630, a network interface 640, a storage interface 650, and the like. These interfaces 630, 640, 650, and the memory 610 and the processor 620 can be connected through the bus 600. The input/output interface 630 can provide a connection interface for input/output devices such as a display, a mouse, a keyboard, and the like. The network interface 640 provides a connection interface for a variety of networking devices. The storage interface 640 provides a connection interface for external storage devices such as a floppy disk, a USB flash disk, and an SD card.

It should be noted that, terms “comprise”, “include”, or any other variation thereof, herein, are intended to cover a non-exclusive inclusion, such that a process, method, article, or apparatus that comprises a list of elements not only comprises those elements, but also comprises other elements not expressly listed, or further comprises elements inherent in such a process, method, article, or apparatus. Without further limitations, an element defined by a statement “comprising a . . . ” does not exclude the presence of another identical element in a process, method, article, or apparatus that comprises the element. Furthermore, it should be noted that the scope of the method and apparatus in the embodiments of the present disclosure is not limited to performing functions in the order illustrated or discussed, but can also comprise performing functions in a substantially simultaneous manner or in a reverse order according to the functions involved, for example, the described method can be performed in a different order from the described order, and various steps can also be added, omitted, or combined. In addition, features described with reference to certain examples can be combined in other examples.

Through the description of the foregoing embodiments, those skilled in the art can clearly understand that the method of the foregoing embodiments can be implemented by means of software plus a necessary general hardware platform, and of course, it can also be implemented by hardware, but in many cases, the former is a better implementation. Based on such understanding, the technical solutions of the present disclosure can be embodied in a form of a software product, wherein the computer software product is stored in a storage medium (such as a ROM/RAM, magnetic disk, optical disk) and comprises several instructions for enabling a terminal (which can be a mobile phone, a computer, a server, an air conditioner, a network device, or the like) to execute the method according to the embodiments of the present disclosure.

While the embodiments of the present disclosure have been described above in conjunction with the accompanying drawings, the present disclosure is not limited to the above specific embodiments.

The above specific embodiments are only illustrative and not restrictive. Under the enlightenment of the present disclosure, without departing from the spirit of the present disclosure and the scope protected by the claims, one of ordinary skill in the art can also make many forms, all of which fall within the protection of the present disclosure.

1. A handwriting recognition method, comprising:
detecting information of a plurality of trajectory points corresponding to a handwritten trajectory of a user on a handwriting screen, the information comprising a coordinate, the plurality of trajectory points comprising a starting trajectory point and a current trajectory point;
determining whether the current trajectory point is an ending trajectory point according to a determining condition, if the current trajectory point meets the determining condition, taking the current trajectory point as the ending trajectory point, and taking trajectory points between the starting trajectory point and the ending trajectory point as first to-be-recognized trajectory points;
recognizing the first to-be-recognized trajectory points by using a text recognition model to obtain a first text recognition result; and
displaying the first text recognition result in a form of print in a first display area of the handwriting screen.

2. The handwriting recognition method according to claim 1, wherein the information further comprises a user writing state, which comprises pen-starting, pen-moving or pen-lifting, the determining condition is that no new trajectory point is detected within a preset duration after a pen-lifting moment of the current trajectory point, and the starting trajectory point is a next trajectory point of a last trajectory point inputted to the text recognition model last time, or a first trajectory point of the handwriting screen.

3. The handwriting recognition method according to claim 1, wherein the displaying the first text recognition result in a form of print in a first display area of the handwriting screen comprises:
storing a plurality of words comprised in the first text recognition result as word trajectories, wherein each word is separately stored as one word trajectory.

4. The handwriting recognition method according to claim 3, wherein the displaying the first text recognition result in a form of print in a first display area of the handwriting screen comprises:
separately drawing each word comprised in the first text recognition result.

5. The handwriting recognition method according to claim 1, comprising, after the displaying the first text recognition result in a form of print:
receiving an erasure operation of the user on a target text in the first text recognition result, and erasing the target text.

6. The handwriting recognition method according to claim 5, wherein:
the erasure operation comprises selecting the target text; or
the erasure operation comprises a first erasure gesture, and the erasing the target text comprises erasing a word trajectory intersected with a trajectory of the first erasure gesture; or
the erasure operation comprises a second erasure gesture, and the erasing the target text comprises erasing a word trajectory intersected with a trajectory of the second erasure gesture and erasing a word trajectory having a same label as the word trajectory

7-8. (canceled)

9. The handwriting recognition method according to claim 5, wherein the label comprises a first label or a second label, wherein the first label comprises row information of a word trajectory, and the second label comprises time information, paragraph information, or batch information of a word trajectory.

10. The handwriting recognition method according to claim 1, wherein the displaying the first text recognition result in a form of print in a first display area of the handwriting screen comprises:
performing row division on the first to-be-recognized trajectory points; and
separately drawing the plurality of words comprised in the first text recognition result row by row according to a result of the row division.

11. The handwriting recognition method according to claim 10, wherein the performing row division on the first to-be-recognized trajectory points comprises:
dividing the first to-be-recognized trajectory points into the plurality of words according to the information of the trajectory points in the first to-be-recognized trajectory points; and
determining whether two adjacent words of the plurality of words are in a same row, wherein the two adjacent words comprise a first word written earlier and a second word written later.

12. The handwriting recognition method according to claim 11, wherein the determining whether two adjacent words are in a same row comprises:
determining whether the two adjacent words are in the same row according to a height and a position coordinate of the second word and a height and a position coordinate of the first word.

13. (canceled)

14. The handwriting recognition method according to claim 1, further comprising:
detecting information of second to-be-recognized trajectory points corresponding to a handwritten trajectory of the user on the handwriting screen, the information comprising a coordinate, the second to-be-recognized trajectory points comprising a starting trajectory point and an ending trajectory point;
determining whether a current trajectory point is the ending trajectory point of the second to-be-recognized trajectory points according to the determining condition, if the current trajectory point meets the determining condition, taking the current trajectory point as the ending trajectory point of the second to-be-recognized trajectory points, and taking trajectory points between the starting trajectory point and the ending trajectory point as the second to-be-recognized trajectory points;
recognizing the second to-be-recognized trajectory points by using the text recognition model to obtain a second text recognition result; and
displaying the second text recognition result in a form of print in a second display area.

15. The handwriting recognition method according to claim 14, wherein the displaying the second text recognition result in a form of print in a second display area comprises:
acquiring display information of the first display area, the display information comprising a size of a font and a coordinate;
determining the second display area according to the display information; and
displaying the second text recognition result in the form of print in the second display area, a size of a font in the second text recognition result being the same as the size of the font in the first text recognition result, a word in the second text recognition result being aligned with a word in the first text recognition result.

16. The handwriting recognition method according to claim 15, wherein the displaying the second text recognition result in a form of print in a second display area comprises:
determining whether the word in the second text recognition result is in the same row as the word in the first text recognition result; and
if the determining result is yes, displaying the word in the second text recognition result in the same row as the word in the first text recognition result.

17. The handwriting recognition method according to claim 16, wherein the determining whether the word in the second text recognition result is in the same row as the word in the first text recognition result comprises:
determining whether the word in the second text recognition result is in the same row as the word in the first text recognition result according to a position coordinate of the word in the second text recognition result and a position coordinate of the word in the first text recognition result.

18. The handwriting recognition method according to claim 17, wherein the determining whether the word in the second text recognition result is in the same row as the word in the first text recognition result comprises:
determining whether a first space between the word in the second text recognition result and the word in the first text recognition result in a row direction of the text is less than a first threshold and whether a second space between the word in the second text recognition result and the word in the first text recognition result in a column direction of the text is less than a second threshold, according to the position coordinate of the word in the second text recognition result and the position coordinate of the word in the first text recognition result; and
determining that the word in the second text recognition result is in the same row as the word in the first text recognition result in the case where the first space is less than the first threshold and the second space is less than the second threshold.

19. The handwriting recognition method according to claim 18, wherein:
the first threshold is in positive correlation with a width of the word in the second text recognition result; and/or
the second threshold is in positive correlation with a height of the word in the first text recognition result.

20-22. (canceled)

23. An interactive display, comprising a touch module, a display, a processor, a memory, and a program or instructions stored on the memory and executable on the processor, wherein the program or instructions, when executed by the processor, implement the steps of the handwriting recognition method according to claim 1.

24. A non-transitory readable storage medium, wherein the readable storage medium has thereon stored a program or instructions, wherein the program or instructions, when executed by a processor, implement the steps of the handwriting recognition method according to claim 1.

25. A handwriting recognition apparatus, comprising:
a memory; and
a processor coupled to the memory, the processor being configured to perform, based on instructions stored in the memory, one or more steps of the handwriting recognition method according to claim 1.

26. A handwriting recognition system, comprising the handwriting recognition apparatus according to claim 25, wherein the handwriting recognition apparatus comprises:
a first processor located on a server side and configured to recognize to-be-recognized trajectory points by using a text recognition model to obtain a text recognition result; and
a second processor located on a terminal side and configured to draw words comprised in the text recognition result one by one and store each word as one word trajectory.
